(19) United States
(12) Patent Application Publication
(10) Pub. No.: US 2013/0130673 A1
(43) Pub. Date: May 23, 2013

(54) METHOD, DEVICE, AND SYSTEM FOR DEVICE MANAGEMENT

(71) Applicant: Huawei Device Co., Ltd., Shenzhen (CN)

(72) Inventors: Yue Song, Shenzhen (CN); Rui Wang, Beijing (CN); Xinmiao Chang, Beijing (CN); Haitao Liu, Beijing (CN)

(73) Assignee: Huawei Device Co., Ltd., Shenzhen (CN)

(21) Appl. No.: 13/725,429

(22) Filed: Dec. 21, 2012

Related U.S. Application Data
(63) Continuation of application No. PCT/CN2011/083778, filed on Dec. 9, 2011.

(30) Foreign Application Priority Data
Dec. 10, 2010 (CN) 201010601410.3

(51) Int. Cl. H04W 4/00

(52) U.S. Cl. 455/419

(57) ABSTRACT

Embodiments of the present invention provide a method, a device, and a system for device management. The method includes: configuring a relevant identifier at a wide area network WAN side for a management object which is of a gateway and is in a management tree of the gateway, and configuring a relevant identifier at a local area network LAN side for a management object which is mapped by at least one terminal and is in the management tree of the gateway.

### CROSS-REFERENCE TO RELATED APPLICATIONS

This application is a continuation of international Application No. PCT/CN2011/083778, filed on Dec. 9, 2011, which claims priority to Chinese Patent Application No. 201010601410.3, filed on Dec. 10, 2010, both of which are hereby incorporated by reference in their entireties.

### FIELD OF THE INVENTION

The present invention relates to the field of communications technologies, and in particular, to a method, a device, and a system for device management.

### BACKGROUND OF THE INVENTION

The Open Mobile Alliance (Open Mobile Alliance, OMA) device management (Device Management, DM) V1.2, briefly referred to as a DM specification in the following, is a unified specification of DM. A DM system provides a low-cost solution which is used for a third party to manage and set environment and configuration information in terminal equipments (for example, a mobile phone terminal and a functional object in the terminal), so as to solve problems emerging in a process of use of the devices. For example, operations such as installation and upgrade of software and firmware are performed in an over the air (over the air, OTA) manner, so as to provide more humanized and personalized services and improve user experience. The third party may be a carrier, a service provider or an information management department of a partner.

Referring to a structural frame diagram of DM shown in FIG. 1, a DM client on a terminal equipment is configured to explain and execute a management command delivered by a DM server. A device management tree stored on the terminal equipment may be considered as an interface through which the DM server manages the terminal equipment, and the DM server communicates with the DM client in the terminal equipment through a DM protocol to implement management of the terminal equipment. The device management tree includes some management objects (Management Object, MO), and the DM server achieves a purpose of managing the terminal equipment by performing operations, such as Get (Get), Replace (Replace), Execute (Exec), Copy (Copy), and Delete (Delete), on the MOs.

The SCOMO is mainly used to standardize processes, such as download, installation, update, and activation, of software components. A server configures a network side software package uniform resource locator (Pkg Uniform Resource Locator, URL) on the device management tree, and sends a command to instruct a terminal to download software, that is, executes a Download (Download) node in the MO by using an Exec command. After the download is completed, the terminal is instructed to install the software components.

In an existing device management method, an MO or a data model of a terminal equipment is mapped to be an MO on a gateway. Referring to FIG. 2, when the server executes a certain operation on the MO on the gateway, the gateway sends a relevant operation to the terminal, so that it is implemented that the server manages the terminal through the MO which is mapped by the terminal and is on the gateway, and the server manages the gateway through an MO on the gateway itself. However, in the prior art, after the server executes an operation on the MO which is mapped by the terminal and is on the gateway, the gateway sends the relevant operation to the terminal. For example, if the server expects the gateway to replace the terminal equipment to download software, the server may configure PkgURL in the SCOMO which is mapped by the terminal and is in the gateway. However, the gateway sends the configuration to the terminal to make the terminal download the software at a wide area network (Wide Area Network, WAN) side, thereby being unable to implement that multiple terminals download the software from the gateway. Therefore, in the prior art, the terminal directly performs information interaction with the wide area network side, and the gateway cannot replace the terminal to perform information interaction with the wide area network, which increases the burden of a wide area network server and wastes a resource of the wide area network.

### SUMMARY OF THE INVENTION

Embodiments of the present invention provide a method, a device, and a system for device management, so as to solve a problem that in the prior art, a terminal directly performs information interaction with a wide area network side, the burden of a wide area network server is increased, and a resource of a wide area network is wasted.

In one aspect, an embodiment of the present invention provides a device management method, including:

configuring a relevant identifier at a wide area network WAN side for a management object which is of a gateway and is in a management tree of the gateway, and configuring a relevant identifier at a local area network LAN side for a management object which is mapped by at least one terminal and is in the management tree of the gateway, where the relevant identifier at the WAN side includes a uniform resource locator at the WAN side, a server identifier at the WAN side, or a server address at the WAN side, and the relevant identifier at the LAN side includes a uniform resource locator at the LAN side, an access identifier of the gateway at the LAN side, or an access address of the gateway at the LAN side; and

triggering the at least one terminal to perform information interaction with the gateway according to the relevant identifier at the LAN side, and triggering the gateway to perform information interaction with a corresponding server at the WAN side according to the relevant identifier at the WAN side.

The present invention further provides a device management server, including:

a configuring module, configured to configure a relevant identifier at a wide area network WAN side for a management object which is of a gateway and is in a management tree of the gateway, and configure a relevant identifier at a local area network LAN side for a management object which is mapped by at least one terminal and is in the management tree of the gateway, where the relevant identifier at the WAN side includes a uniform resource locator at the WAN side, a server identifier at the WAN side, or a server address at the WAN side, and the relevant identifier at the LAN side includes a uniform resource locator at the LAN side, an access identifier of the gateway at the LAN side, or an access address of the gateway at the LAN side; and

a triggering module, configured to trigger the at least one terminal to perform information interaction with the gateway according to the relevant identifier which is at the LAN side and is configured by the configuring module, and trigger the gateway to perform information interaction with a corresponding server at the WAN side according to the relevant identifier which is at the WAN side and is configured by the configuring module.

In another aspect, an embodiment of the present invention provides a device management system, including a device management server, a gateway, and at least one terminal, where

the device management server is configured to configure a relevant identifier at a wide area network WAN side for a management object which is of the gateway and is in a management tree of the gateway, and configure a relevant identifier at a local area network LAN side for a management object which is mapped by the at least one terminal and is in the management tree of the gateway, where the relevant identifier at the WAN side includes a uniform resource locator at the WAN side, a server identifier at the WAN side, or a server address at the WAN side, and the relevant identifier at the LAN side includes a uniform resource locator at the LAN side, an access identifier of the gateway at the LAN side, or an access address of the gateway at the LAN side; and trigger the at least one terminal to perform information interaction with the gateway according to the relevant identifier at the LAN side, and trigger the gateway to perform information interaction with a corresponding server at the WAN side according to the relevant identifier at the WAN side;

the at least one terminal is configured to perform information interaction with the gateway according to the relevant identifier at the LAN side; and

the gateway is configured to perform information interaction with the corresponding server at the WAN side according to the relevant identifier at the WAN side.

In a method, a device, and a system for device management provided in the embodiments of the present invention, a relevant identifier at a WAN side is configured for an MO which is of a gateway and is in a management tree of the gateway, so that the gateway directly performs information interaction with a server at the WAN side, and a relevant identifier which is at a local area network (Local Area Network, LAN) side and points to a certain location in the gateway is configured in an MO which is mapped by a terminal and is in the gateway, so that the terminal can perform information interaction with a gateway side, and does not need to perform information interaction with the WAN side, thereby alleviating the burden of a server at the WAN side and saving a resource of a wide area network.

### BRIEF DESCRIPTION OF THE DRAWINGS

FIG. 1 is a structural frame diagram of device management;

FIG. 2 is a schematic structural diagram of mapping of a terminal equipment to a gateway in the prior art;

FIG. 3 is a flow chart of a first embodiment of a device management method according to the present invention;

FIG. 4 is a schematic diagram of a second embodiment of a device management method according to the present invention;

FIG. 5 is a schematic diagram of a third embodiment of a device management method according to the present invention;

FIG. 6 is a schematic diagram of a fourth embodiment of a device management method according to the present invention;

FIG. 7 is a schematic structural diagram of a first embodiment of a device management server according to the present invention;

FIG. 8 is a schematic structural diagram of a second embodiment of a device management server according to the present invention; and

FIG. 9 is a schematic structural diagram of a first embodiment of a device management system according to the present invention.

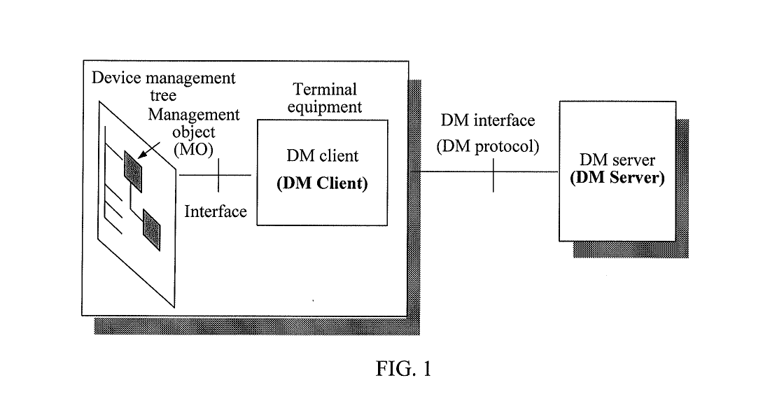

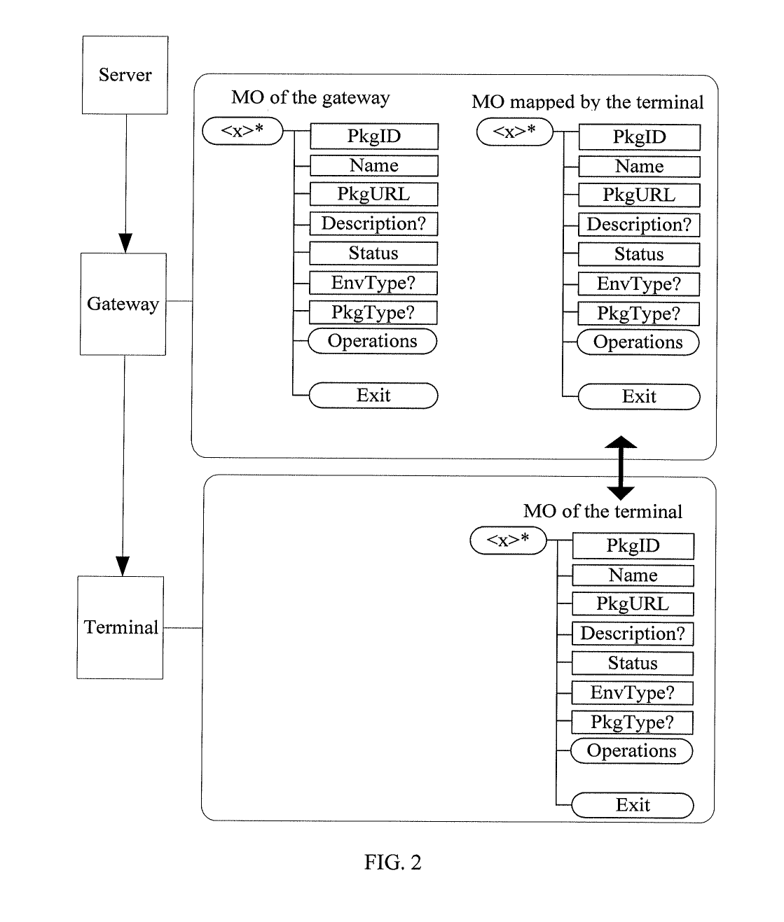

### DETAILED DESCRIPTION OF THE EMBODIMENTS

The technical solutions of the present invention are further described in detail in the following with reference to the accompanying drawings and embodiments.

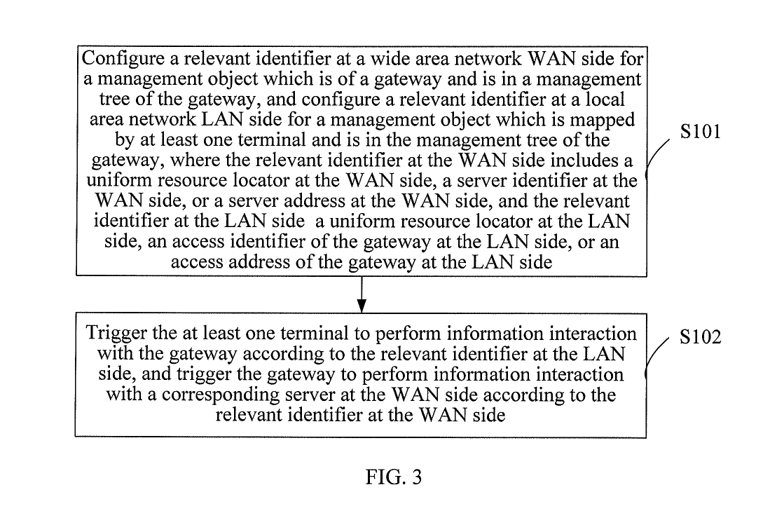

FIG. 3 is a flow chart of a first embodiment of a device management method according to the present invention. As shown in FIG. 3, the method includes:

S101: Configure a relevant identifier at a wide area network WAN side for a management object which is of a gateway and is in a management tree of the gateway, and configure a relevant identifier at a local area network LAN side for a management object which is mapped by at least one terminal and is in the management tree of the gateway, where the relevant identifier at the WAN side includes a uniform resource locator at the WAN side, a server identifier at the WAN side or a server address at the WAN side, and the relevant identifier at the LAN side includes a uniform resource locator at the LAN side, an access identifier of the gateway at the LAN side or an access address of the gateway at the LAN side.

S102: Trigger the at least one terminal to perform information interaction with the gateway according to the relevant identifier at the LAN side, and trigger the gateway to perform information interaction with a corresponding server at the WAN side according to the relevant identifier at the WAN side.

It should be noted that, an execution subject of the forgoing steps is a device management server, that is, the DM Server.

In one aspect, the device management server may configure the relevant identifier at the WAN side for the management object which is of the gateway and is in the management tree of the gateway. Specifically, the device management server may create an MO in the management tree of the gateway, and configure a relevant identifier at the wide area network WAN side for the MO; or the device management server may also configure an existing MO in the management tree of the gateway. The relevant identifier at the WAN side may be a URL at the WAN side, or the server identifier at the WAN side or the server address at the WAN side. Since the MO is a management object which is of the gateway and is in the management tree of the gateway, when the device management server triggers the gateway to execute a certain operation, that is, the device management server performs a certain operation, for example, an operation such as download or session initiation, on a node in the MO, the gateway can perform a corresponding interaction operation with the corresponding server at the WAN side according to the relevant identifier which is at the WAN side and is configured by the server.

In another aspect, for an MO which is mapped by at least one terminal and exists in the gateway, generally, multiple MOs may exist. The device management server may configure the relevant identifier at the local area network LAN side for the MO mapped by the terminal, so as to instruct the at least one terminal to perform information interaction with the gateway at a location corresponding to the relevant identifier at the LAN side. The relevant identifier at the LAN side may be a URL of the gateway at the LAN side, an access identifier of the gateway at the LAN side or an access address of the gateway at the LAN side, where the access identifier of the gateway at the LAN side includes a local access path of the gateway. Since the relevant identifier at the LAN side points to a set location in the gateway, when the device management server triggers the terminal to execute a certain operation, that is, the device management server performs a certain operation on a node in the MO which is mapped by the terminal and is in the gateway, because the node exists in the MO which is mapped by the terminal and is in the gateway, the gateway may forward the configuration for the node and the operation to a corresponding terminal, and the terminal performs information interaction with the gateway in the set location which is in the gateway and is pointed to by the relevant identifier at the LAN side.

In the device management method provided in this embodiment, a relevant identifier at a WAN side is configured for an MO which is of a gateway and is in a management tree of the gateway, so that the gateway directly performs information interaction with a server at the WAN side, and a relevant identifier which is at an LAN side and points to a certain location in the gateway is configured for an MO which is mapped by a terminal and is in the gateway, so that the terminal can perform information interaction with a gateway side and does not need to perform information interaction with the WAN side, thereby alleviating the burden of the server at the WAN side and saving a resource of a wide area network.

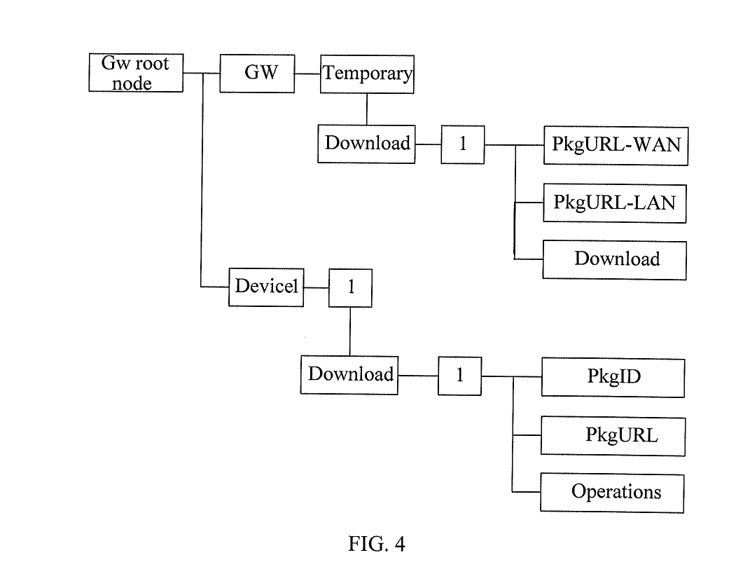

The device management method provided in the embodiment of the present invention may be applied in multiple application scenes. FIG. 4 is a schematic diagram of a second embodiment of the device management method according to the present invention. In this embodiment, a case that a device management server, that is, the DM Server, triggers a gateway to replace a terminal to perform a download operation is taken as an example for description, and reference is made to FIG. 4.

In one aspect, the device management server may create an MO in a management tree of the gateway, where the MO is a management object of the gateway, and the device management server configures a relevant identifier at a WAN side for the created MO. In an application scene provided in this embodiment, the relevant identifier at the WAN side may be a PkgURL of a software package at the WAN side (PkgURL-WAN under ./GW/Temporary/Download/1 in FIG. 4). The device management server further configures a relevant identifier at an LAN side for the created MO. In this application scene, the relevant identifier at the LAN side is a PkgURL at the LAN side (PkgURL-LAN under ./GW/Temporary/Download/1 in FIG. 4), and the Pkg URL at the LAN side points to an access path of downloaded data stored in the gateway. In addition, the device management server further adds a Download node (Download node under ./GW/Temporary/Download/1 in FIG. 4) in the created MO, so as to execute the download operation.

After the foregoing configuration process is completed, the device management server triggers the gateway to execute a download operation, that is, execute a download operation on the foregoing Download node. Since the node is a management object which is of the gateway and is in the management tree, the gateway can execute a download action. The gateway performs the download operation on a corresponding server at the WAN side according to the foregoing configured PkgURL-WAN, that is, performs information interaction with the corresponding server at the WAN side. After the completion of the download, the gateway stores the downloaded data in a location designated by the PkgURL at the LAN side, that is, a location designated by a value of the node PkgURL-LAN. The value of the PkgURL-LAN may be a local URL which is of the gateway and is configured by the device management server. For example, the value may be a local Internet Protocol (Internet Protocol, IP) address, port, and designated directory or address of the gateway.

In another aspect, the device management server may further configure a node in an MO which is mapped by at least one terminal and is in the gateway, for example, configure a PkgURL at the LAN side for an SCOMO which is mapped by a terminal Device1 and is in the gateway, where a node value of a ./Device1/1/Download/1/PkgURL node is a node value of the foregoing PkgURL-LAN. In addition, the device management server may further configure an operation node Operations and sub-nodes under Operations for the MO which is mapped by the at least one terminal and is in the gateway.

After the device management server configures the node in the MO which is mapped by the terminal and is in the gateway, the device management server may execute a download operation on the sub-node under Operations, for example, execute an /Operations/Download node. Since the foregoing nodes are located in the MO which is mapped by the terminal Device1 and is in the gateway, the gateway forwards the configuration of the nodes and the operation executed to Device1. Specifically, the device management server configures a corresponding SCOMO sub-tree, that is, a Download sub-tree, on Device1, and executes a Download node in the sub-tree. Since in this case, a value of the node is equal to the value of the foregoing PkgURL-LAN node, that is, a URL on the gateway, Device1 performs the download operation on the gateway according to the node value of the configured PkgURL.

In the device management method provided in this embodiment, in one aspect, Pkg URL addresses at the WAN side and at the LAN side are configured for the MO which is of the gateway and is in the management tree of the gateway; and in another aspect, an LAN side address pointing to the local gateway is configured in the MO which is mapped by the terminal and is in the gateway, which implements a function that the device management server performs software distribution through the gateway, that is, the gateway downloads software on the WAN side in place of the terminal, so that the terminal merely needs to download the software on the gateway and does not need to download the software from the corresponding server at the WAN side, thereby alleviating the burden of the server at the WAN side, and saving a network resource at the WAN side.

In the second embodiment of the device management method, the PkgURL at the LAN side, that is, the relevant identifier at the LAN side, is configured by the device management server. As another exemplary implementation manner, the relevant identifier at the LAN side may be further pre-designated by the gateway, that is, the device management server merely needs to configure a PkgURL at a WAN side in an MO of a gateway, after the configuration, the device management server triggers the gateway to perform download on a corresponding server at the WAN side according to a node value of the configured PkgURL-WAN, and after the completion of the download, the gateway may designate a local URL and store the software in the URL, where the URL may specifically be an IP address, port, and designated directory or address of the gateway. The gateway adds the URL as a node value to the PkgURL-LAN node.

Afterwards, the device management server may acquire the value of the PkgURL-LAN node from the gateway to configure an MO which is mapped by a terminal and is in the gateway. For example, the device management server configures an SCOMO mapped by a terminal Device1, and sets a ./Device1/1/Download/1/PkgURL node in the SCOMO, where a value of the node is equal to a node value which is of the PkgURL-LAN and is acquired by the device management server from the gateway. After the completion of the configuration, the device management server triggers the terminal to perform a download operation, that is, the device management server executes a sub-node under Operations, for example, executes an /Operations/Download node. Since the foregoing nodes are located in an MO which is mapped by Device1 and is in the gateway, the gateway forwards the configuration for the nodes and the operation executed to Device1. Specifically, the device management server configures a corresponding SCOMO sub-tree, that is, a Download sub-tree, on Device1, and executes a Download node in the sub-tree. Since a value of the node is equal to the value of the foregoing PkgURL-LAN node, that is, a URL on the gateway, Device1 performs the download operation on the gateway according to the node value of the configured PkgURL.

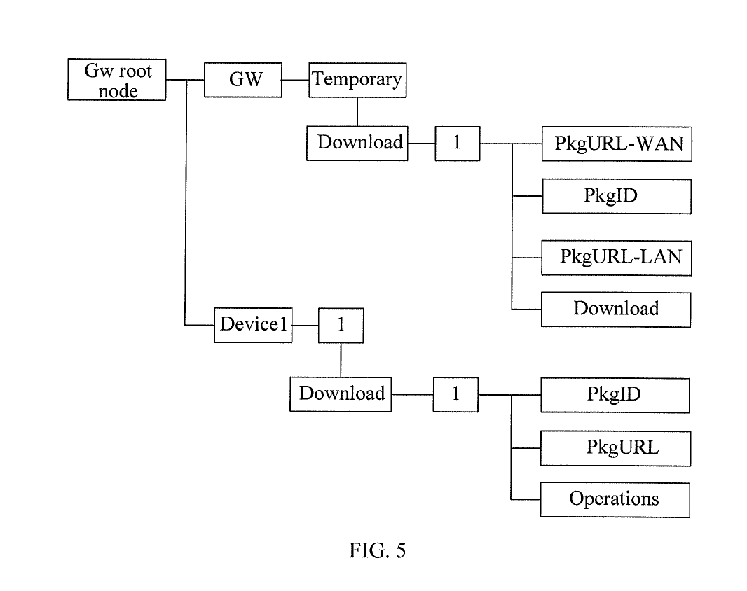

In the foregoing description, the device management server needs to add the PkgURL-LAN node in the MO in the management tree of the gateway, and the device management server configures a URL of the PkgURL-LAN, or the gateway pre-designates a local URL. As another feasible implementation manner, the device management server or the gateway may not add the node value to the PkgURL-LAN node, or may not generate the node. FIG. 5 is a schematic diagram of a third embodiment of the device management method according to the present invention. Reference is made to FIG. 5.

A device management server may create an MO in a management tree of a gateway, and configure a PkgURL of a software package at a WAN side (that is, a relevant identifier at the WAN side), and then the device management server may further configure a first data packet identifier (referring to the ./GW/Temporary/Download/1/PkgID node in FIG. 5) for information interaction between the gateway and the WAN side. The gateway may record correspondence between a pre-designated local URL and the first data packet identifier.

When configuring a ./Device1/1/Download/1 sub-tree in an MO which is mapped by the terminal and is in the gateway, the device management server configures a second data packet identifier (that is, a ./Device1/1/Download/1/PkgID node in FIG. 5) for information interaction between the terminal and the gateway, where the second data packet identifier is the same as the first data packet identifier. The gateway may add a designated URL to the PkgURL node under ./Device1/1/Download/1 as a node value according to the recorded correspondence between the local designated URL and the first data packet identifier. In this embodiment, the node value of ./Device1/1/Download/1/PkgURL may also be pre-designated by the gateway.

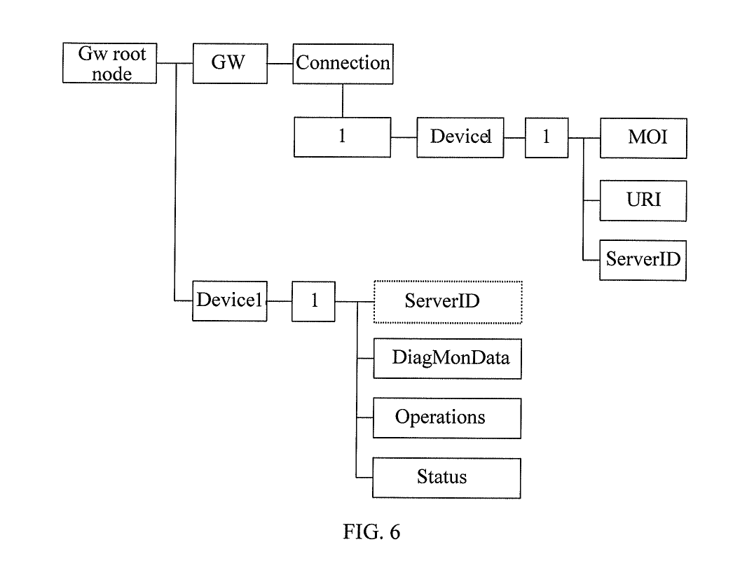

FIG. 6 is a schematic diagram of a fourth embodiment of a device management method according to the present invention. In this embodiment, a fault diagnosis scene is taken as an example for description.

Referring to FIG. 6, in one aspect, a device management server, that is, the DM Server, may create an MO in a device management tree of a gateway, and the device management server configures a relevant identifier of a WAN, that is, a DiagMon ServerID, for the created MO. A node value of .GW/Connection/1/ServerID shown in FIG. 6 may be an identifier or an address of a diagnostic monitoring server or a relevant server at the WAN side. The device management server may further configure an attribute identifier (an MOI and/or a URL) for the created MO, where the MOI is used to indicate that an attribute of the created MO is a diagnostic monitoring function management object, and the MOI may specifically be urn:oma:mo:oma-diag:paniclog:1.0.

In another aspect, the device management server configures a node in an MO which is mapped by a terminal and is in the gateway, for example, configures a DiagMon Function MO mapped by a terminal Device1, and sets a value of a ./Device1/1/ServerID node to be a relevant identifier at an LAN side, where the relevant identifier at the LAN side is an access identifier of the gateway at the LAN side, and the terminal may access the gateway according to the access identifier of the gateway at the LAN side. A Type attribute of ./Device1/1 is an MOI of Function MO, that is, urn:oma:mo:oma-diag:paniclog:1.0. In addition, the device management server may further configure another node in the DiagMon Function MO, for example, nodes such as DiagMonData, Operations and their sub-nodes, and Status.

After the foregoing configuration, the device management server executes a sub-node under Operations, for example, executes an /Operations/Start node. Since the node is located in an MO which is mapped by the terminal Device1 and is in the gateway, the gateway forwards the configuration of the nodes and the operation executed to Device1, specifically, sends the configuration and the operation to the corresponding DiagMon Function MO on Device1, and executes a Start node in it.

Afterwards, Device1 starts to perform diagnostic monitoring on itself. After collecting data, since a local identifier or address of the gateway is configured for a ServerID node in the MO which is mapped by Device1 and is in the gateway, Device1 initiates a session to the gateway, informs the gateway that data is collected, and sends the data to the gateway.

After receiving the data, the gateway stores the data in ./Device1/1/DiagMonData in the MO mapped by the terminal Device1, and then, the gateway searches ./GW/Connection/1/according to a Type attribute value MOI of the ./Device1/1 node, that is, urn:oma:mo:oma-diag:paniclog:1.0, specifically, searches for whether a node value of the MOI in each sub-tree of ./GW/Connection/1/is equal to the Type attribute value, and if it is found that the node value of the MOI in a ./GW/Connection/1/Device1/1 sub-tree is equal to the Type value, the gateway initiates a session to a diagnostic monitoring server or a relevant server designated by the node value of ./GW/Connection/1/Device1/1/ServerID, and sends the data stored in ./Device1/1/DiagMonData.

It should be noted that, if searching according to the URL, after the gateway receives the data and stores the data in ./Device1/1/DiagMonData, the gateway searches for, in ./GW/Connection/1/Device1, whether a node value of the URL in each sub-tree of ./GW/Connection/1/Device1 is equal to ./Device1/1, initiates a session to a diagnostic monitoring server or a relevant server designated by the node value of ./GW/Connection/1/Device1/1/ServerID, and sends the data stored in ./Device1/1/DiagMonData.

In the device management method provided in this embodiment, in one aspect, the device management server configures DiagMon ServerID (that is, a relevant identifier at the WAN side) and an MOI (management object identifier) and/or a URL (uniform resource locator) node (that is, a relevant identifier at the LAN side) for an MO which is of the gateway and is in the management tree of the gateway; and in another aspect, the device management server configures DiagMon Function MO which is mapped by a terminal and is in the gateway, so that the gateway collects diagnostic data from the terminal, finds an identifier or an address of a server at the WAN side, and sends the diagnostic data to the server at the WAN side (that is, information interaction between the terminal and the gateway, and information interaction between the gateway and the WAN side).

Persons of ordinary skill in the art should understand that all or part of the steps of the foregoing method embodiments may be implemented by a program instructing relevant hardware. The foregoing program may be stored in a computer readable storage medium. When the program runs, the program executes the steps of the foregoing method embodiments. The foregoing storage medium may be various media capable of storing program codes, including a ROM, a RAM, a magnetic disk or a compact disk.

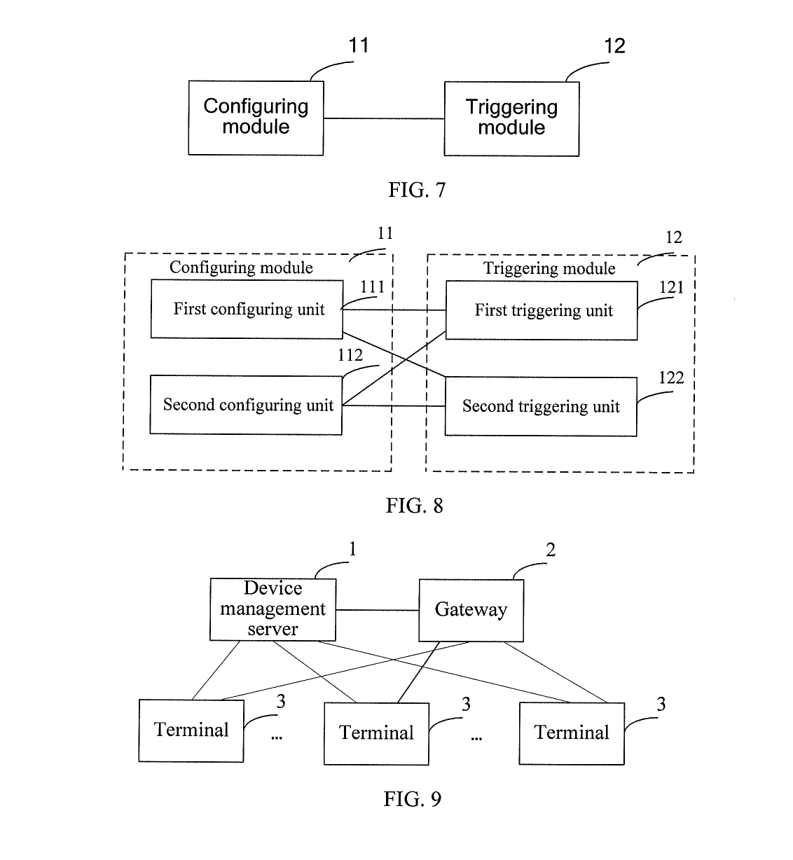

FIG. 7 is a schematic structural diagram of a first embodiment of a device management DM server according to the present invention. Referring to FIG. 7, the device management server includes a configuring module 11 and a triggering module 12.

The configuring module 11 is configured to configure a relevant identifier at a wide area network WAN side for a management object which is of a gateway and is in a management tree of the gateway, and configure a relevant identifier at a local area network LAN side for a management object which is mapped by at least one terminal and is in the management tree of the gateway, where the relevant identifier at the WAN side includes a uniform resource locator at the WAN side, a server identifier at the WAN side or a server address at the WAN side, and the relevant identifier at the LAN side includes a uniform resource locator at the LAN side, an access identifier of the gateway at the LAN side or an access address of the gateway at the LAN side.

The triggering module 12 is configured to trigger the at least one terminal to perform information interaction with the gateway according to the relevant identifier which is at the LAN side and is configured by the configuring module 11, and trigger the gateway to perform information interaction with a corresponding server at the WAN side according to the relevant identifier which is at the WAN side and is configured by the configuring module 11.

In the device management server provided in this embodiment, a relevant identifier at a WAN side is configured for an MO which is of a gateway and is in a management tree of the gateway, so that the gateway directly performs information interaction with a relevant server at the WAN side, and a relevant identifier which is at an LAN side and points to a certain location in the gateway is configured for an MO which is mapped by a terminal and is in the gateway, so that the terminal can perform information interaction with the gateway side and does not need to perform information interaction with the WAN side, thereby alleviating the burden of the server at the WAN side and saving a resource of a wide area network.

FIG. 8 is a schematic structural diagram of a second embodiment of a device management DM server according to the present invention. Referring to FIG. 8, based on the foregoing embodiment,

optionally, a triggering module 12 may further include a first triggering unit 121 and/or a second triggering unit 122.

The first triggering unit 121 is configured to, when the relevant identifier at the WAN side is a uniform resource locator of a software package at the WAN side, the relevant identifier at the LAN side is a uniform resource locator of the software package at the LAN side, and the uniform resource locator at the LAN side points to an access path of downloaded data stored in the gateway, trigger the gateway to perform a download operation on a corresponding server at the WAN side according to the uniform resource locator at the WAN side, and trigger the at least one terminal to perform a download operation on the gateway according to the uniform resource locator at the LAN side.

The second triggering unit 122 is configured to, when the relevant identifier at the WAN side is the server identifier at the WAN side or the server address at the WAN side, and the relevant identifier at the LAN side is the access identifier of the gateway at the LAN side or the access address of the gateway at the LAN side, trigger the at least one terminal to send data to the gateway according to the access identifier of the gateway at the LAN side or the access address of the gateway at the LAN side, and trigger the gateway to send data to the corresponding server at the WAN side according to the server identifier at the WAN side or the server address at the WAN side.

Optionally, the configuring module 11 may include a first configuring unit 111 and/or a second configuring unit 112.

The first configuring unit 111 is configured to configure a relevant identifier at the local area network LAN side for the management object which is mapped by the at least one terminal and is in the gateway.

The second configuring unit 112 is configured to acquire a relevant identifier which is at the LAN side and is pre-designated by the gateway, and configure the management object which is mapped by the at least one terminal and is in the gateway.

In the device management server provided in this embodiment, a relevant identifier at a WAN side is configured for an MO which is of a gateway and is in a management tree of the gateway, so that the gateway directly performs information interaction with a server at the WAN side, and a relevant identifier which is at an LAN side and points to a certain location in the gateway is configured in an MO which is mapped by a terminal and is in the gateway, where the identifier may be configured by the server, and may also be pre-designated by the gateway, so that the terminal can perform information interaction with the gateway side and does not need to perform information interaction with the WAN side, thereby alleviating the burden of the server at the WAN side and saving a resource of a wide area network.

The embodiments of the device management server provided in the present invention correspond to the embodiments of the device management method provided in the present invention, which show a functional device for implementing the device management method provided in the present invention. For details, reference may be made to the foregoing method embodiments, which is not repeatedly described here again.

FIG. 9 is a schematic structural diagram of a first embodiment of a device management system according to the present invention. Referring to FIG. 9, the system includes a device management server 1, a gateway 2 and at least one terminal 3.

The device management server 1 is configured to configure a relevant identifier at a wide area network WAN side for a management object which is of the gateway and is in a management tree of the gateway 2, and configure a relevant identifier at a local area network LAN side for a management object which is mapped by the at least one terminal 3 and is in the management tree of the gateway 2, where the relevant identifier at the WAN side includes a uniform resource locator at the WAN side, a server identifier at the WAN side or a server address at the WAN side, and the relevant identifier at the LAN side includes a uniform resource locator at the LAN side, an access identifier of the gateway 2 at the LAN side or an access address of the gateway 2 at the LAN side; and trigger the at least one terminal 3 to perform information interaction with the gateway 2 according to the relevant identifier at the LAN side, and trigger the gateway 2 to perform information interaction with a corresponding server at the WAN side according to the relevant identifier at the WAN side.

The at least one terminal 3 is configured to perform information interaction with the gateway 2 according to the relevant identifier at the LAN side.

The gateway 2 is configured to perform information interaction with the corresponding server at the WAN side according to the relevant identifier at the WAN side.

In the device management system provided in this embodiment, a device management server configures a relevant identifier at a WAN side for an MO which is of a gateway and is in a management tree of the gateway, so that the gateway directly performs information interaction with a server at the WAN side, and configures a relevant identifier which is at an LAN side and points to a certain location in the gateway for an MO which is mapped by a terminal and is in the gateway, where the relevant identifier at the LAN side may be configured by the device management server, and may also be pre-designated by the gateway, so that the terminal can perform information interaction with the gateway side and does not need to perform information interaction with the WAN side, thereby alleviating the burden of a server at the WAN side and saving a resource of a wide area network.

Finally, it should be noted that the foregoing embodiments are merely used for describing the technical solutions of the present invention, but not intended to limit the present invention. It should be understood by persons of ordinary skill in the art that although the present invention is described in detail with reference to the foregoing embodiments, modifications can still be made to the technical solutions recorded in each foregoing embodiment, or equivalent replacements can be made to some technical features in the technical solutions, as long as the modifications or replacements do not make the essence of corresponding technical solutions to depart from the spirit and scope of the technical solutions of each embodiment of the present invention. The method is applicable to information routing and forwarding by a routing node in various other wireless communication networks.

What is claimed is:

1. A device management method, comprising:
configuring a relevant identifier at a wide area network WAN side for a management object which is of a gateway and is in a management tree of the gateway, and configuring a relevant identifier at a local area network LAN side for a management object which is mapped by at least one terminal and is in the management tree of the gateway, wherein the relevant identifier at the WAN side comprises a uniform resource locator at the WAN side, a server identifier at the WAN side, or a server address at the WAN side, and the relevant identifier at the LAN side comprises a uniform resource locator at the LAN side, an access identifier of the gateway at the LAN side, or an access address of the gateway at the LAN side; and
triggering the at least one terminal to perform information interaction with the gateway according to the relevant identifier at the LAN side, and triggering the gateway to perform information interaction with a corresponding server at the WAN side according to the relevant identifier at the WAN side.

2. The method according to claim 1, wherein
when the relevant identifier at the WAN side is a uniform resource locator of a software package at the WAN side, the relevant identifier at the LAN side is a uniform resource locator of the software package at the LAN side, and the uniform resource locator at the LAN side points to an access path of downloaded data stored by the gateway,
the triggering the at least one terminal to perform information interaction with the gateway according to the relevant identifier at the LAN side, and triggering the gateway to perform information interaction with the corresponding server at the WAN side according to the relevant identifier at the WAN side comprises:
triggering the gateway to perform a download operation on the corresponding server at the WAN side according to the uniform resource locator at the WAN side; and
triggering the at least one terminal to perform a download operation on the gateway according to the uniform resource locator at the LAN side.

3. The method according to claim 1, wherein
when the relevant identifier at the WAN side is the server identifier at the WAN side or the server address at the WAN side, and the relevant identifier at the LAN side is the access identifier of the gateway at the LAN side or the access address of the gateway at the LAN side,
the triggering the at least one terminal to perform information interaction with the gateway according to the relevant identifier at the LAN side, and triggering the gateway to perform information interaction with the corresponding server at the WAN side according to the relevant identifier at the WAN side comprises:
triggering the at least one terminal to send data to the gateway according to the access identifier of the gateway at the LAN side or the access address of the gateway at the LAN side; and
triggering the gateway to send data to the corresponding server at the WAN side according to the server identifier at the WAN side or the server address at the WAN side.

4. The method according to claim 1, wherein the configuring the relevant identifier at the local area network LAN side for the management object which is mapped by the at least one terminal and is in the management tree of the gateway comprises:
configuring the relevant identifier at the LAN side for a management object which is mapped by the at least one terminal and is in the gateway; or
acquiring a relevant identifier which is at the LAN side and is pre-designated by the gateway, and configuring a management object which is mapped by the at least one terminal and is in the gateway.

5. A device management DM server, comprising:
a configuring module, configured to configure a relevant identifier at a wide area network WAN side for a management object which is of a gateway and is in a management tree of the gateway, and configure a relevant identifier at a local area network LAN side for a management object which is mapped by at least one terminal and is in the management tree of the gateway, wherein the relevant identifier at the WAN side comprises a uniform resource locator at the WAN side, a server identifier at the WAN side, or a server address at the WAN side, and the relevant identifier at the LAN side comprises a uniform resource locator at the LAN side, an access identifier of the gateway at the LAN side, or an access address of the gateway at the LAN side; and
a triggering module, configured to trigger the at least one terminal to perform information interaction with the gateway according to the relevant identifier which is at the LAN side and is configured by the configuring module, and trigger the gateway to perform information interaction with a corresponding server at the WAN side according to the relevant identifier which is at the WAN side and is configured by the configuring module.

6. The DM server according to claim 5, wherein the triggering module comprises:
a first triggering unit, configured to, when the relevant identifier at the WAN side is a uniform resource locator of a software package at the WAN side, the relevant identifier at the LAN side is a uniform resource locator of the software package at the LAN side, and the uniform resource locator at the LAN side points to an access path of downloaded data stored by the gateway, trigger the gateway to perform a download operation on the corresponding server at the WAN side according to the uniform resource locator at the WAN side, and trigger the at least one terminal to perform a download operation on the gateway according to the uniform resource locator at the LAN side.

7. The DM server according to claim 5, wherein the triggering module comprises:
a second triggering unit, configured to, when the relevant identifier at the WAN side is the server identifier at the WAN side or the server address at the WAN side, and the relevant identifier at the LAN side is the access identifier of the gateway at the LAN side or the access address of the gateway at the LAN side, trigger the at least one terminal to send data to the gateway according to the access identifier of the gateway at the LAN side or the access address of the gateway at the LAN side, and trigger the gateway to send data to the corresponding server at the WAN side according to the server identifier at the WAN side or the server address at the WAN side.

8. The DM server according to claim 5, wherein the configuring module comprises:
a first configuring unit, configured to configure the relevant identifier at the LAN side for a management object which is mapped by the at least one terminal and is in the gateway.

9. The DM server according to claim 5, wherein the configuring module comprises:
a second configuring unit, configured to acquire a relevant identifier which is at the LAN side and is pre-designated by the gateway, and configure the management object which is mapped by the at least one terminal and is in the gateway.

10. A device management system, comprising a device management server, a gateway, and at least one terminal, wherein
the device management server is configured to configure a relevant identifier at a wide area network WAN side for a management object which is of the gateway and is in a management tree of the gateway, and configure a relevant identifier at a local area network LAN side for a management object which is mapped by the at least one terminal and is in the management tree of the gateway, wherein the relevant identifier at the WAN side comprises a uniform resource locator at the WAN side, a server identifier at the WAN side, or a server address at the WAN side, and the relevant identifier at the LAN side comprises a uniform resource locator at the LAN side, an access identifier of the gateway at the LAN side, or an access address of the gateway at the LAN side; and trigger the at least one terminal to perform information interaction with the gateway according to the relevant identifier at the LAN side, and trigger the gateway to perform information interaction with a corresponding server at the WAN side according to the relevant identifier at the WAN side;
the at least one terminal is configured to perform information interaction with the gateway according to the relevant identifier at the LAN side; and
the gateway is configured to perform information interaction with the corresponding server at the WAN side according to the relevant identifier at the WAN side.
